(19) United States
(12) Patent Application Publication
(10) Pub. No.: US 2007/0169647 A1
(43) Pub. Date: Jul. 26, 2007

(54) Servomechanical inker for a container decorator

(76) Inventor: Earl P. Conrad, McComb, OH (US)

Correspondence Address: SHERIDAN ROSS PC, 1560 BROADWAY, SUITE 1200, DENVER, CO, 80202, US

(21) Appl. No.: 11/331,491

(22) Filed: Jan. 13, 2006

(51) Int. Cl. B41F 5/00

(52) U.S. Cl. 101/216

(57) ABSTRACT

An improved inking apparatus is provided that omits the use of the bull gear generally known in the art. More specifically, bull gears have traditionally been used in inking apparatus to rotate pinion gears that rotate shafts interconnected to plate cylinders. Plate cylinders in turn apply ink to a blanket that ultimately applies indicia to a container such as a beverage can. The rotating shaft also communicates with a plurality of gears that operate the inking stations that transfer the ink onto the plate cylinder. One embodiment of the present invention omits the bull gear and the pinion gears and provides an electro-mechanical driver that rotates the shafts to allow a controller to monitor and individually control the timing of plate cylinder rotation and inker station gear rotation thereby increasing efficiency and maintenance personnel safety.

### FIELD OF THE INVENTION

The present invention relates to apparatus for applying ink and indicia to a container. More specifically, one embodiment of the present invention includes a plurality of servo-mechanical motors that rotate shafts interconnected to plate cylinders that transfers ink and indicia to a blanket that applies the inked pattern onto a container.

### BACKGROUND OF THE INVENTION

Automated container decorating apparatus are generally employed to apply indicia, such as artwork, designs, trademarks, etc. onto a container, such as a metallic beverage can. An apparatus indicative of the state of the art is disclosed in U.S. Pat. No. 6,651,552 to Didonato (“Didonato”), which is incorporated by reference in its entirety herein. The Didonato apparatus includes an infeed that directs containers onto a spindle disc that includes a plurality of mandrels depending therefrom that receive the containers and allows them to rotate relative to the spindle disc. A print section, defined by a bull gear and a blanket cylinder, rotates on an axis substantially parallel to the axis of rotation of the spindle disc. The bull gear and the blanket cylinder are situated along the same rotational axis but are spaced a predetermined distance from each other. As the bull gear rotates, a plurality of pinion gears engaged therewith are rotated that each rotate a shaft. The shafts interconnected to the pinion gears are also interconnected to inker station gears that mechanically communicate with an inker station, which will be explained further below. The terminal end of the shaft is interconnected to a cylinder that includes a plate positioned therearound.

As the bull gear rotates, the individual pinion gears rotate their individual shafts, thereby rotating the inker station gears and the plate cylinders. The rotating inker station gears rotate additional gears positioned in the inker station that are interconnected to a plurality of rollers that facilitate the transfer of ink from a reservoir of the inker station onto the plate that is situated on the cylinder. As the cylinder rotates, it contacts a blanket that is positioned around the blanket cylinder, thereby depositing ink in a predetermined pattern thereon. Inker apparatus include a plurality of inker stations that each place a separate, colored pattern onto a portion of the blanket. As the blanket cylinder rotates, the individual inked portions of the blanket engage the containers positioned on the mandrels to deposit a multi-colored design on each container. After the individual containers have been inked, they are directed to a varnisher, oven, etc. and expelled from the apparatus to be directed to another location in the facility.

One drawback in inkers currently used in a container manufacturing plant is that they require a high degree of labor to change the plates, i.e. labels, that are positioned on the plate cylinders. The often difficult task of replacing the plate increases the frequency of employee contact with the machinery, thereby increasing the probability of accidents. In addition, the presence of the bull gear renders access to the pinion gears more difficult which increases accidents due to impingements with the gear teeth by a technician's hands or fingers, for example.

Another drawback is that “spoilage” occurs as a result of maintaining the apparatus of the prior art. When label changes are performed and the plate cylinders are re-incorporated into the inker apparatus, a plurality of containers must be inked to ensure that the pinion gears are correctly clocked and the timing is correct so that the plates' images are placed on the blanket at the proper location. More specifically, since the pinion gears and associated shafts are often moved during maintenance and label replacement, the rotational position of the rollers of the inker station and the rotational position of the plate cylinder will necessarily change. Thus, a multitude of containers must be inked and adjustments made to the components of the apparatus to ensure that the finished product is within acceptable tolerances. This “spoilage”, i.e., discarding misprinted containers, increases production costs attributed to the loss of materials and, more importantly, time related to system fine tuning subsequent to each label change.

Yet another drawback of the prior art inking apparatus is that the risk of mechanical failures increases that are time consuming to repair. More specifically, the bull gear is a moving component that may potentially fail and cause cascading failures within the system. Further, objects may from time to time fall between the teeth of the bull gear that interact with the pinion gears, thereby causing damage. In addition, the presence of the bull gear increases the torque required to be generated by the motor that rotates the bull gear and the blanket cylinder, which is directly related to the life span of the motor.

Still another problem with the inking apparatus of the prior art are vibrations generated by the interaction between the teeth of the bull gear and the teeth of the pinion gears. More specifically, it has been shown through testing that vibrational accelerations of about 4 Gs can be directly attributed to the movement of the gears of the system. The vibrational loads tend to chatter the gear teeth of the system, thereby reducing their lifespan and contributing to poor quality designs being applied to the container. Vibrations that affect interaction between teeth may also cause the metallic teeth of the gears to fatigue and deform over time, thereby affecting gear mesh that causes wobbling that may lead to container misprinting.

Still yet another drawback of currently used inkers may be directly attributed to the acceleration and deceleration of the bull gear. The prior art bull gear system is designed to rotate at a constant velocity, thus acceleration and deceleration of the bull gear necessarily affects the application of the ink onto the container. More specifically, as the bull gear speeds up or slows down, the distribution of ink onto the plate cylinder and the rotation of the plate cylinder will be affected, ultimately resulting in spoilage attributed to pattern shift and color variations of the design being placed on a container. Thus, the “registration” timing from applying the ink is critical to assure that a clear, consistent image is applied to the container.

Thus, it is a long felt need in the field of container production to provide an inking apparatus that reduces spoilage and employee accident risks associated with maintenance. The following disclosure describes an improved inking apparatus that replaces the plurality of pinion gears with a plurality of servo-mechanical motors, thus eliminating the need for the bull gear and ultimately improving operating efficiency and reducing costs.

### SUMMARY OF THE INVENTION

It is one aspect of the present invention to provide a container inking apparatus that applies a predetermined multi-colored design onto a container, such as a metallic beverage container. More specifically, one embodiment of the present invention increases the efficiency of prior art inking apparatus by replacing a plurality of pinion gears that are rotated by a bull gear with a plurality of servo-mechanical motors (“servo motors”). One embodiment of the present invention utilizes a servo motor associated with each inker station of the inker apparatus. The servo motor generally includes a shaft that is interconnected to a plate cylinder that includes an arcuate plate with a design depending therefrom. Each shaft rotates the plate cylinder and an ink station gear associated with the inker station. As the ink station gears rotate, a plurality of rollers inside the inker station rotate to deposit ink onto the plate cylinder. As the plate cylinder rotates, it engages a segment of a blanket cylinder that includes an elastic or rubber blanket designed to deposit an inked pattern on the blanket. As the blanket cylinder rotates, the inked pattern progresses to an adjacent inker station to receive another inked design. This process is repeated until the inked portion of the blanket interacts with all of the colors and designs that are to be placed on the container. Once the blanket portion is completely inked, it is rotatably positioned adjacent to a container that is interconnected to a mandrel positioned on a spindle disc rotating in an opposite direction of the blanket cylinder. As the blanket cylinder engages the container, the container rotates due to the frictional force imparted by the blanket thereby facilitating deposition of the inked design onto the outer surface of the container. Although these types of inkers are generally used to apply a design to a metallic container, the invention described herein is applicable for applying ink or other medium to any type of container or surface, and is not limited to metallic surfaces.

As briefly mentioned above, each shaft that is rotated by each servo motor is interconnected to an inker shaft gear that is in operable engagement with a plurality of gears that are situated inside the inker station. Each inker station also includes a reservoir containing ink of a predetermined color. As the gears of the inker station rotate, they rotate the plurality of rollers that transfer ink from the reservoir onto the plate cylinder. Since the bull gear is designed to rotate the plurality of pinion gears that rotate the plate cylinder and the inker shaft gears, it is advantageous to provide a system that allows for more accurate timing of the individual component rotations, thereby helping to ensure that the proper design is placed on the blanket. Thus, one embodiment of the present invention allows for the servo motors to be selectively adjusted, or “tuned”, to ensure that the ink emanating from the inker station is placed on the plate cylinder at the correct location and that the rotation of the plate cylinder is such that the design carried by the plate cylinder is placed on the blanket at the proper location.

It is still yet another aspect of the present invention to provide an inker station that reduces the amount of time to replace the plates, also referred to in the art as “labels”, that are interconnected to the plate cylinders. More specifically, each prior art apparatus require an individual to remove the pinion gears in order to remove each plate cylinder shaft along with each plate cylinder to replace the plates. Once the plate changes were finished, the heavy pinion gears would have to be operably engaged to the bull gear, thus increasing the risk of injury to maintenance personnel, for example, from pinching their fingers between the gear teeth of the pinion gear and the bull gear. Thus, one embodiment of the present invention omits the pinion gears and includes a coupler that interconnects the servo motors directly to the shafts, thereby allowing the servo motors to be disconnected from the shaft to facilitate maintenance activities. In addition, once the new plates are placed on the plate cylinders, the servo motors allow for selective adjustments to help ensure that the timing of the system is such that the inked plates contact the blanket at the correct location. This aspect of the invention also reduces down time wherein the production facility thereby increases efficiency.

It is yet another aspect of the present invention to provide an inking apparatus that reduces heat generated by the interaction of the blanket onto the cylinders. More specifically, as the bull gear of the prior art inking apparatus rotates, it rotates the inker shaft gears that cooperate with the plurality of gears of the inker station to rotate rollers interconnected thereto. Each of the rollers of the inker station, which will be described in more detail below, are in direct contact, thereby allowing the ink to be efficiently transferred from the ink reservoir onto the plate cylinder. Incorrect meshing of the pinion gear to the bull gear may cause the inker shaft gear to unevenly load the gears of the inker station in such a way to increase friction between the rollers. This friction generates heat between the rollers that may have adverse affects on the rubber rollers themselves, and that may cause ink degradation. Embodiments of the present invention that include the plurality of servo motors instead of a bull gear allow for a more precise interaction between the rollers to decrease unwanted heat generation.

It is still yet another aspect of the present invention to provide an inking apparatus that reduces vibration. With the omission of the bull gear, one major source of vibrational acceleration is omitted. Thus, some of the ill effects that are related to vibrations are reduced, such as wear and tear on the teeth that may increase gear chatter, wear and excessive noise during the transfer of the design onto the container.

It is another aspect of the present invention to provide an inking apparatus that improves graphic quality and reduces spoilage and maintenance activity on the system. More specifically, since preferred embodiments of the present invention do not include the bull gear and associated pinion gears, gear “back lash” is reduced. Gear back lash is the interaction of the bull gear onto the pinion gears which is most apparent during acceleration and deceleration. The servo motors may be designed such that their rotational rate is closely controlled, with a computer for example, thereby helping to eliminate the back lash effects of acceleration/deceleration. The addition of a plurality of servo motors also reduces maintenance costs. Further, when a servo motor does fail, it is easily replaced by another servo motor thereby decreasing downtime.

Further, it is still yet another aspect of the present invention that an inker apparatus be provided that potentially reduces off-colored “Hold for Inspection” (HFIs) by constantly maintaining a tighter tolerance registration than typical gear drives. More specifically, HFIs are color irregularity or smudges that cause a non-ideal image to be deposited upon the blanket. This non-ideal image is then deposited on the container thereby increasing spoilage. The addition of the servo motors allows an operator to selectively fine tune each servo motor to ensure the correct timing throughout the system which leads to tighter tolerances of the inking apparatus and allows for more complex designs to be placed on the container.

It is a further aspect of the present invention to provide a control system to operatively control one or more servo-motors used in conjunction with the present design. This control system in one embodiment is a computer with programmable software which utilizes a plurality of control parameters to efficiently operate the inker, including but not limited to speed, timing, acceleration and deceleration of the inker.

Thus, it is one aspect of the present invention to provide a container inking apparatus comprising:

a plurality of ink stations comprising a plurality of gears interconnected to shafts that control the application of ink onto an application drum;

a plurality of servomechanical motors in mechanical communication with said plurality of gears of said plurality of ink stations; and

wherein said plurality of servomechanical motors control the selective rotation of said plurality of gears to dictate the location of ink onto a blanket for application of ink to a container.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a front view of an inker apparatus commonly employed to selectively apply ink to a container;

FIG. 2 is a schematic representing the manner of selectively applying ink to a container with the apparatus shown in FIG. 1;

FIG. 3 is a rear partial elevation view of the apparatus shown in FIG. 1;

FIG. 4 is a detailed view of the inker station shown in FIG. 3;

FIG. 5 is a top plan view of the portion of the inker apparatus shown in FIG. 3;

FIG. 6 is a front partial elevation view of the inker apparatus shown in FIG. 1;

FIG. 7 is a detailed rear elevation view of a portion of the inker apparatus shown in FIG. 6;

FIG. 8 is a schematic illustrating the application of ink on to a blanket that interacts with the container;

FIG. 9 is a detailed view of FIG. 8;

FIG. 10 is a detailed view of FIG. 8 showing the contact between a plate and the blanket;

FIG. 11 is a detailed view showing the blanket engaged onto a container;

FIG. 12 is a schematic of the method of applying ink to the container of one embodiment of the present invention;

FIG. 13 is a partial rear elevation view of an inker apparatus of one embodiment of the present invention;

FIG. 14 is a detailed view of FIG. 13;

FIG. 15 is a top elevation view of the embodiment of the present invention shown in FIG. 13;

FIG. 16 is a schematic showing one embodiment of the present invention; and

FIG. 17 is a block diagram showing a method of controlling a servo motor utilized in one embodiment of the present invention.

To assist in the understanding of the present invention the following list of components and associated numbering found in the drawings is provided herein:

| # | Component |
|---|---|
| 2 | Inker apparatus |
| 4 | Container |
| 6 | Mandrill |
| 8 | Blanket cylinder (segmented wheel) |
| 10 | Spindle disc |
| 12 | Blanket |
| 16 | Inker station |
| 18 | Roller (generally) |
| 18A | Fountain roller |
| 18B | Ducting roller |
| 18C | Fixed roller |
| 18D | Form roller |
| 18E | Vibrating roller |
| 20 | Plate cylinder |
| 22 | Plate |
| 24 | Bull gear |
| 26 | Pinion gear |
| 30 | Inker gear |
| 32 | Servo motor |
| 34 | Inker Shaft Gear |
| 36 | Plate cylinder shaft |
| 38 | Ink fountain |
| 40 | Leading edge |
| 42 | Trailing edge of the plate |
| 44 | Shaft coupling |
| 46 | Encoder |
| 48 | Inker servo motor/encoder |
| 50 | Operator interface |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

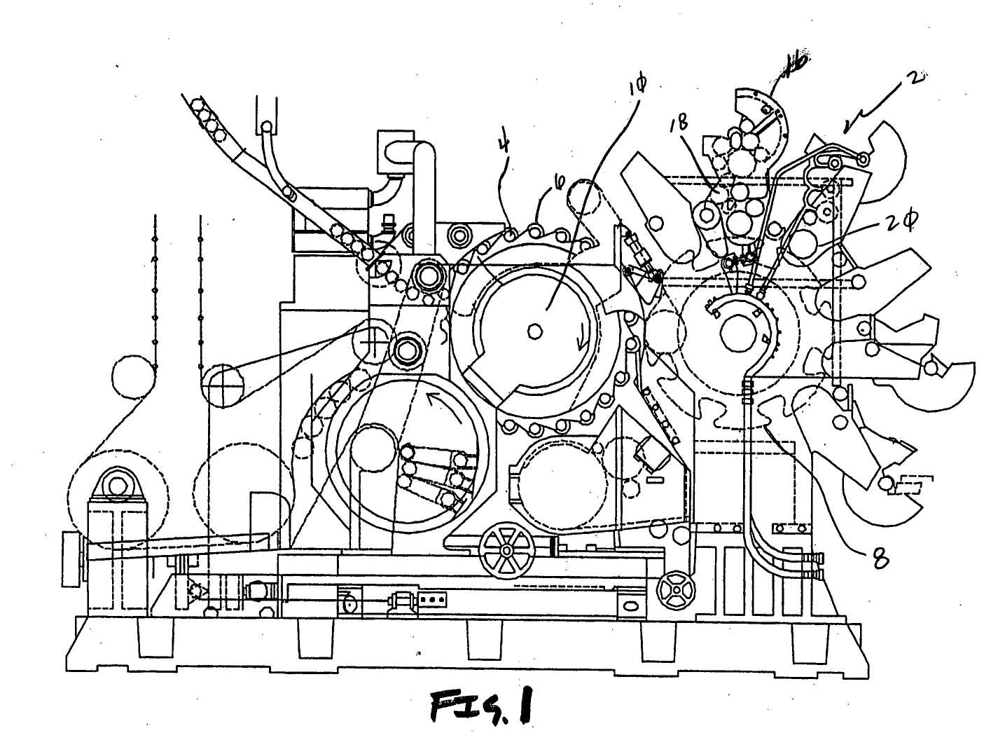

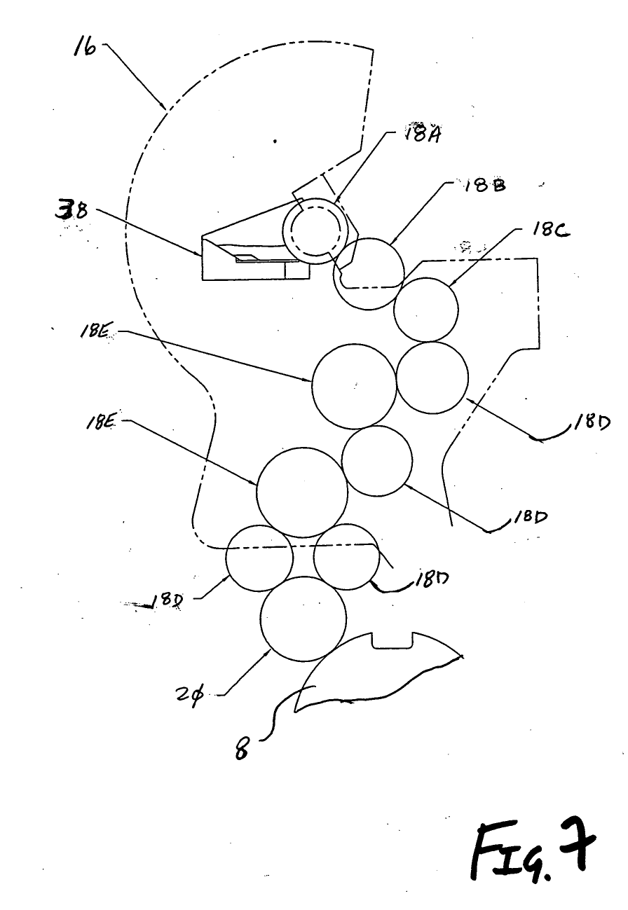

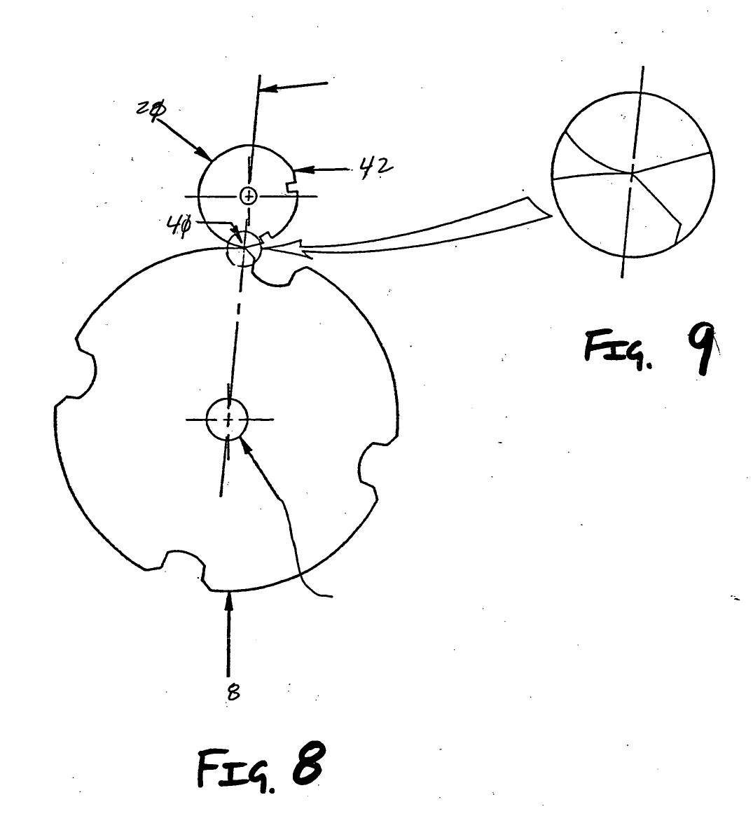

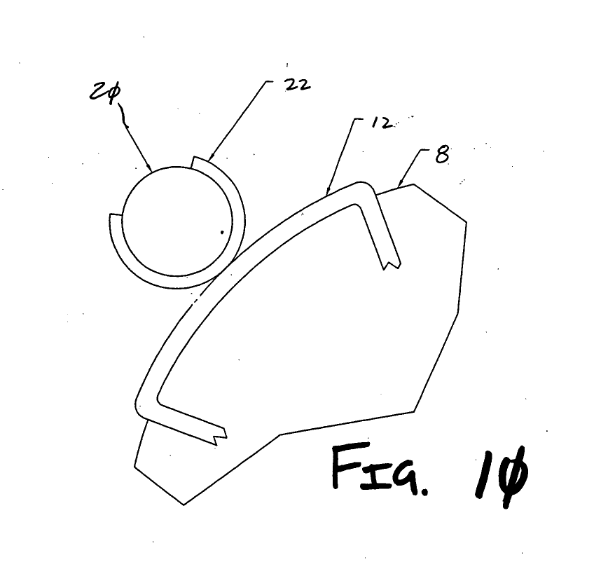

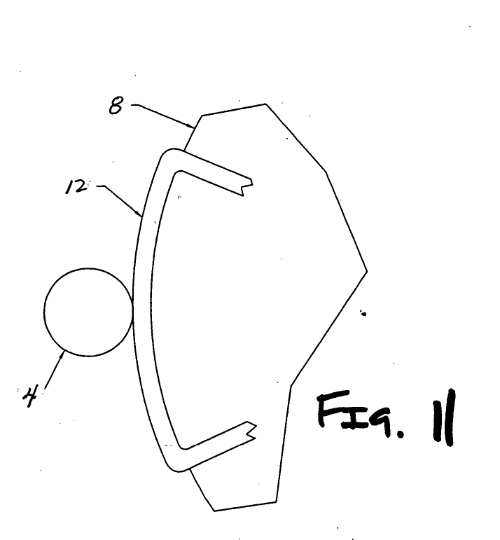

Referring now to FIGS. 1-17, an inker apparatus 2 is shown that applies various colors of ink onto a container 4. More specifically, inker apparatus 2 are well known in the art wherein a plurality of containers 4 are fed onto a rotating mandrel 6. A blanket cylinder 8 is also included that rotates parallel to, and in conjunction with, a spindle disc 10 that secures the mandrel 6. A blanket 12 wrapped around the blanket cylinder 8 is selectively coated with ink from a plurality of individual inker stations 16. The ink from the inker stations 16 is applied via rollers 18 onto a plate cylinder 20 that secures a plate 22 with a raised design. Once the various colors of ink are individually applied onto their corresponding plates 22, the ink from each plate is deposited on a segment of the blanket 12. When the inked blanket 12 is placed adjacent to the container 4, which is situated on the mandrel 6 of the spindle disc 10, the oppositely rotating members will rotate the container 4 to deposit the ink thereon. The container 4 is then transferred to an oven and out of the inking apparatus 2.

One embodiment of the present invention replaces a bull gear 24, which is interconnected to the blanket cylinder 8 via a single shaft, with a plurality of servo motors. The bull gear 24 is traditionally interconnected to a plurality of pinion gears 26 that rotate a plate cylinder shaft 36 and the plate cylinder 20. The inker gear 34 is interconnected to various gears 30 of the inker station 16 that rotate rollers 18 interconnected thereto. As the bull gear 24 rotates it turns the pinion gears 26 that rotates the plate cylinders 20 and the gears 30 associated with inker station 16. As briefly mentioned above, certain embodiments of the present invention replace the pinion gears 26, (thus omitting the need for the bull gear 24), with an electro-mechanical “servo” motors 32 that are directly interconnected to the plate cylinder shaft 36. The plurality of servo motors 32 each may be selectively adjusted to ensure that the proper ink patterns are placed upon the blanket 12.

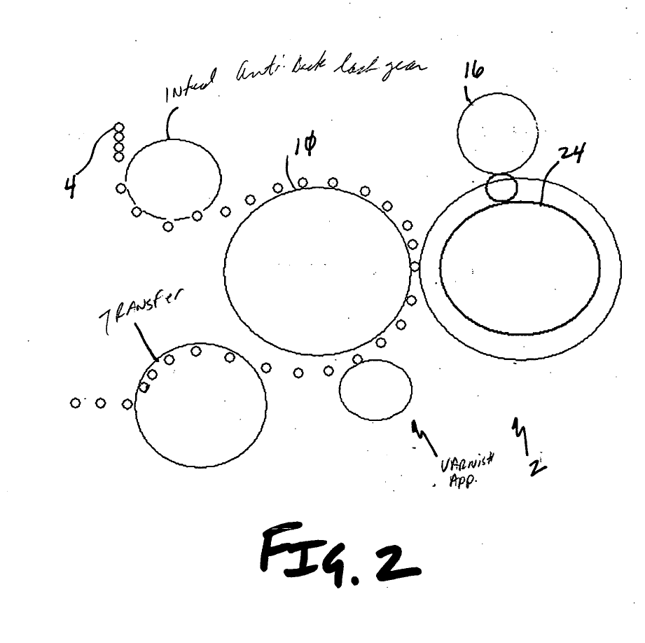

Referring now to FIGS. 1 and 2, a prior art inker apparatus 2 is provided herein. More specifically, containers 4 are directed onto a spindle disc 10 that includes a plurality of mandrels 6 that interface with each container 4. As the spindle disc 10 is rotated (in the FIG. 1 clockwise), the containers 4 are individually positioned adjacent to a rotating blanket cylinder 8 (here, counterclockwise). The blanket cylinder 8 is driven by a shaft (not shown) that is also interconnected to a bull gear (not shown). The blanket of the segmented blanket cylinder 8 receives ink from the plurality of inker stations 16 via a plurality of plate cylinders 20. As the blanket interacts with the plurality of inker stations 16, a design is deposited thereon. When the inked blanket comes in contact with the containers 4 situated on the mandrel 6, frictional force between the container 4 to and the blanket will cause the container 4 to rotate relative to the spindle disc 10, thereby rotating the container 4 to transfer the pattern of the plate onto the container 4. Once the container 4 has been inked, it is transferred to varnishers and/or ovens to permanently affix the ink and design onto the container 4. The containers 4 are then diverted to another location in the production facility.

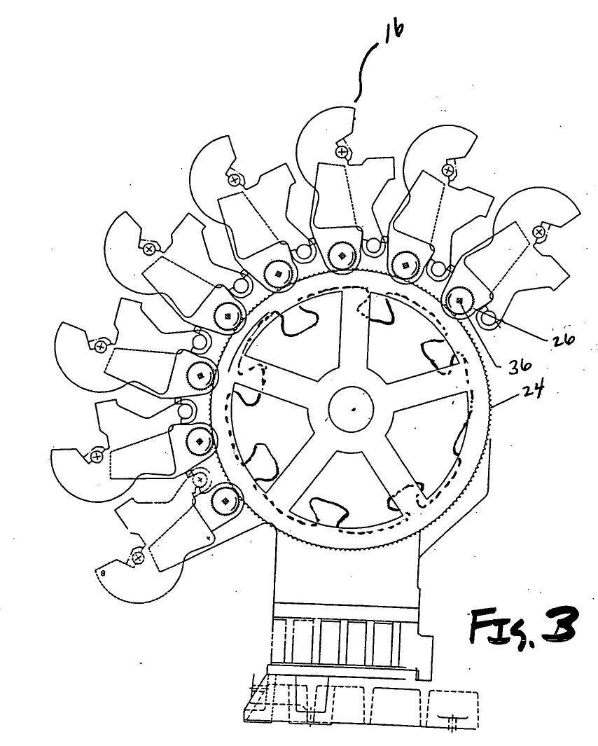

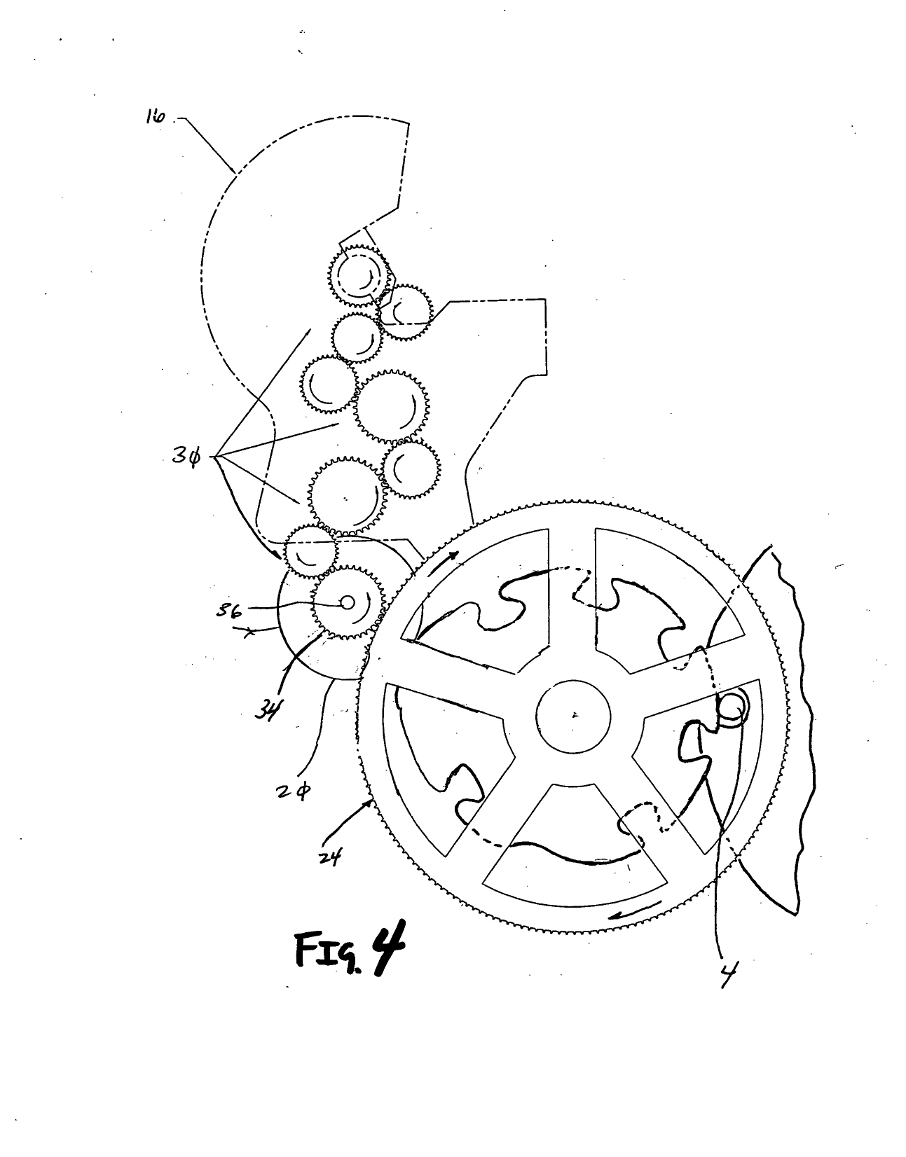

Referring now to FIGS. 3 and 4, a portion of the inking apparatus 2 is shown with some components removed for clarity. As shown herein, the bull gear 24 and the blanket cylinder 8 are interconnected via a single shaft, i.e. they share the same rotational axis. As a motor rotates the bull gear 24 and the blanket cylinder 8, the teeth of the bull gear 8 interface with a plurality of pinion gears 26 and cause them to rotate. The pinion gears 26 are each interconnected to the plate cylinder shaft 36 that is interconnected to the plate cylinder 20, which will be described in further detail below.

In FIG. 4, the pinion gear 26 has been removed for clarity and the inker shaft gear 34 is shown which cooperates with a plurality of inker shaft gears 30. The inker shaft gears 30 are interconnected to shafts that are in turn interconnected to rollers that transfer ink from a reservoir to the plate cylinder 20. As the plate cylinder shaft 35 rotates, the ink is transferred onto the plate that is interconnected to the plate cylinder 20, that ultimately transfers the ink onto the blanket 12. The inked portion of the blanket 12 is then rotatably positioned adjacent to a container to deposit the ink pattern thereon.

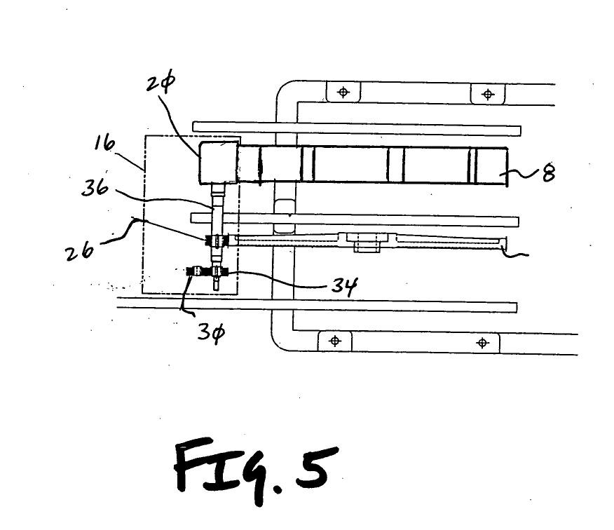

Referring now to FIG. 5, a top plan view of the portion of the inker apparatus is shown with ancillary components removed for clarity. Here, it is illustrated how the plate cylinder shaft 36 is shared by the plate cylinder 20, the pinion gear 26, and the inker gear 34. As the bull gear 24 rotates, it rotates the pinion gears 26 that rotate the plate cylinder shafts 36. This rotation causes the plate cylinders 20 to rotate, thereby selectively contacting the blanket positioned about the blanket cylinder 8. In addition, rotation of the plate cylinder shafts 36 causes the inker gears 34 to rotate, thereby interacting with the inker shaft gears 30 that actuate rollers that transfer ink onto the plate cylinders 20, which will be shown and described in more detail below. Thus, an inking system is provided wherein the rotation of the bull gear 24 is utilized to time the rotation of the plate cylinders 20, dictating the location on the segmented portion of the blanket cylinder the inked design will be placed. In addition, the bull gear 24 times the inker shaft gears 30 that dictate the placement of the individual colors of ink onto the plate cylinder 20.

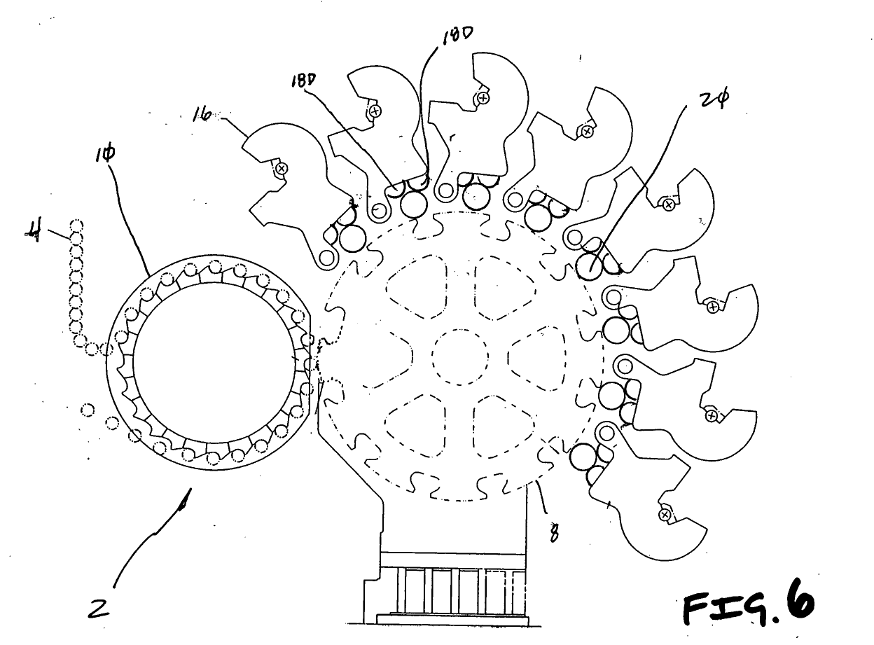

Referring now to FIGS. 6-11, the inking portion of a typical process is shown. More specifically, these figures concentrate on the opposite side of the inking apparatus 2, wherein emphasis is directed towards the application of ink onto the plate cylinder 20 and the blanket 12 of the blanket cylinder 8. As discussed above, a plurality of inker stations 16 are generally employed, each generally containing a different color of ink. The inks are contained in a reservoir, or ink fountain 38, situated within the inker station 16. The ink fountain 38 is in contact with a fountain roller 18A that pulls ink from the fountain 38 and places onto an adjacent ducting roller 18B. Ink from the ducting roller 18B is transferred onto a fixed roller 18C and then transferred onto a form roller 18D. Next, the ink moves from the form roller 18D onto a vibrating roller 18E, onto another form roller 18D, onto another vibrating roller 18E, and onto yet another set of form rollers 18D. The ink is then placed onto a plate 22 that is interconnected to the plate cylinder 20. The plate 22, which is well known in the art, is generally an accurate metallic member that includes a raised design on one side thereof. Each individual inking color has associated with it a unique plate that receives that particular ink color on the raised portion thereof. For example, one plate may read the words “MADE IN THE USA” to be placed onto a container. Yet another plate, associated with another color, may include a trademark of a product. The individual plates when viewed together would not necessarily have their raised portions overlapping such that the individual colors when placed on a product would be separated. Alternatively, it is well understood in the art that shadowed designs or any other designs are possible.

Once the plate 22 has received its ink, it rotates along with the plate cylinder 20 to deposit a design onto the blanket 12 interconnected to the segmented blanket cylinder 8. As the segment portion of the blanket cylinder 8 rotates, it interacts with the next plate cylinder 20 having a different design plate 22 and a different color wherein a second color of ink is applied to the blanket 12. More specifically, as the leading edge 40 of the plate cylinder 20 interconnects with the leading edge 40 of the blanket cylinder 8, a unique design is placed on the blanket 12. Once the blanket cylinder 8 is rotated away from all of the inking stations and the predetermined design is positioned thereon, it contacts the container 4 positioned on the mandrel 6 thereby rotating that container and depositing its design thereon.

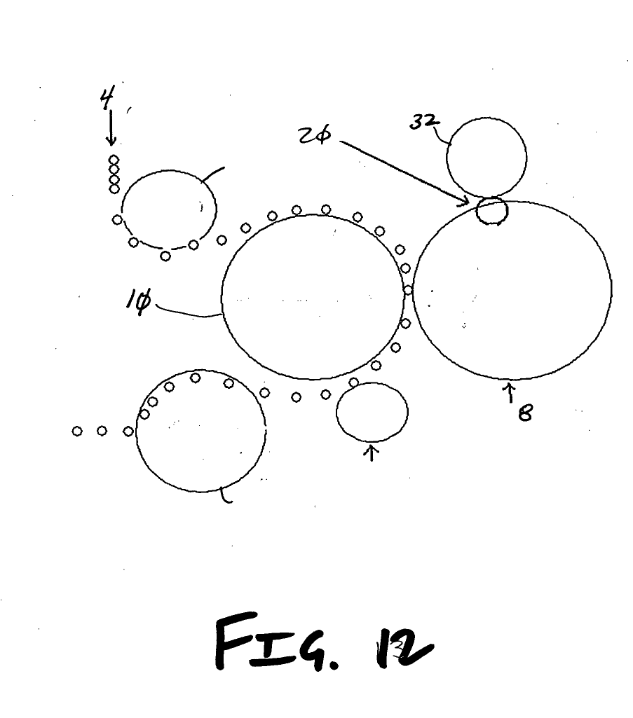

Referring now to FIG. 12, one embodiment of the present invention is shown that omits the use of the pinion gears and bull gear and employs instead a plurality of servo motors 32. Since the pinion gears are no longer required to rotate the plate cylinder shaft, the bull gear is no longer required. The plurality of servo motors 32 provides the necessary rotation that drive the inker stations and the plate cylinders 20. The shaft that previously held both the bull gear and the blanket is still rotated by the motor. However, one skilled in the art will appreciate that the bull gear may remain associated to the system wherein it contacts no other gearing. This may be desirable and there may be advantages of this configuration if, for example, the servo motors 32 are inoperable for any reason, the pinion gears 26 may be integrated back into the system or re-engaged onto the bull gear so that production may continue. Alternatively, the system run by servo motors 32 may be employed as a secondary measure wherein the bull gear is employed as in the prior art, however, if there is a problem with the bull gear, the servo motors 32 may be used to continue operations.

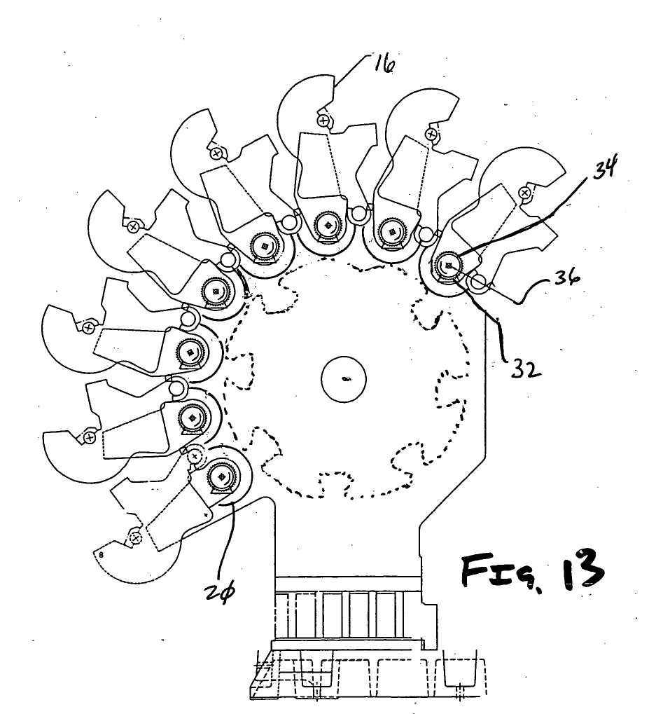

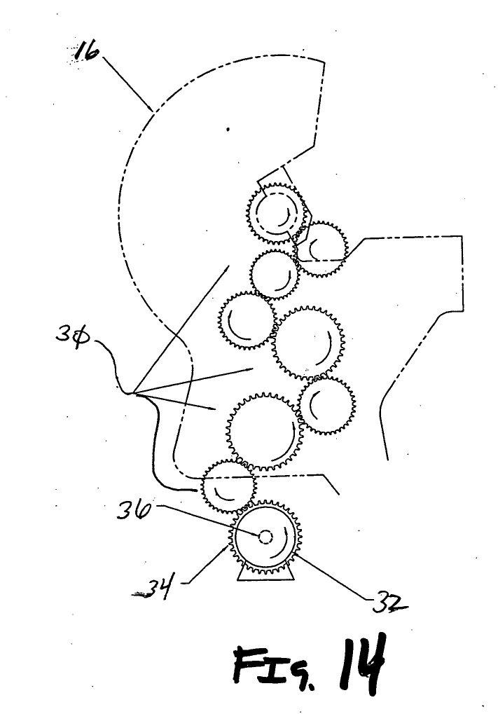

Referring now to FIGS. 13 and 14, one embodiment of the present invention is shown that employs a plurality of servo motors 32. More specifically, here the plurality of pinion gears have been replaced with a plurality of servo motors 32. In addition, the bull gear has been removed. Thus, the servo motors 32 rotate the plate cylinder shaft 36 to rotate the inker gear 34. As the plate cylinder shaft 36 rotates, so does the inker gear 34, which initiates rotation of the various gears 30 inside the inker station 16 as in the prior art. Ink is then deposited onto the plate cylinder 20 as described above. The plate cylinder shaft 36 also rotates the plate cylinder (not shown) that interacts with the blanket also as described above. The advantages with this embodiment of the present invention is that the individual servo motors 32 may be selectively fine tuned to ensure that the ink is deposited onto the blanket as desired. In addition, the weight of the bull gear is removed from the system thus decreasing loads on the motor spinning the blanket cylinder, which may extend the lifetime of the motor.

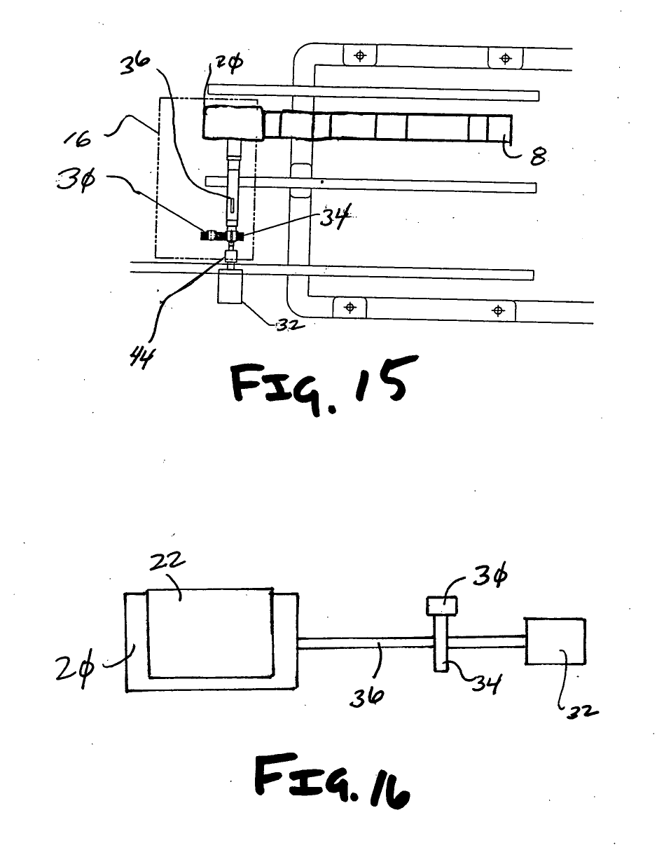

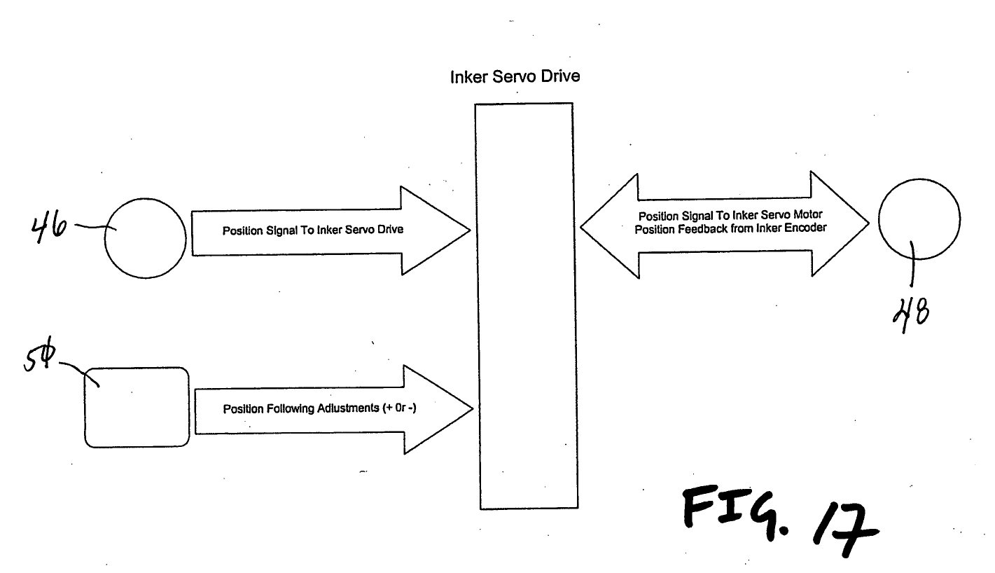

Referring now to FIGS. 15 and 16, a top plan view of one embodiment of the present is shown along with a schematic thereof. A shaft coupling 44 is added to the end of the plate cylinder shaft 36 that is interconnected to the servo motor 32. As the servo motor 32 rotates the plate cylinder shaft, the inker gear 34 rotates to interact with a plurality of inker shaft gears 30 as described above. In addition, the rotation of the plate cylinder shaft 36 rotates the plate cylinder 20 as also described above.

Referring now to FIG. 17, a block diagram of the inker servo drive is shown. In one embodiment of the present invention, an encoder 46 is attached to the main shaft that interconnects to the motor that drives the blanket cylinder. In addition, an inker servo motor/encoder 48 is operably interconnected to the segment wheel. An operator interface 50 is also provided that allows for the position signal of the main shaft to be communicated and compared to the position signal of the inker servo motor to therefore allow for fine adjustments of each servo motor. This ensures that the correct pattern is placed on the blanket at the correct location for an acceptable finished product.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A container inking apparatus, comprising:
an inking station comprising a plurality of interconnected gears, each of said gears interconnected to a roller, and each of said rollers being adapted to transfer ink from a reservoir to a plate cylinder;
a servomechanical motor interconnected to said plate cylinder by a shaft;
an inker gear positioned on said shaft, said inker shaft in communication with said gears of said inking station; and
wherein said servomechanical motor rotates said shaft, thereby rotating said plate cylinder, said inker gear, said gears of said inking station, and said rollers to deposit ink onto said plate cylinder.

2. The apparatus of claim 1, wherein said plate cylinder includes an arcuate plate interconnected thereto having a raised portion for receiving ink, and wherein said ink is generally transferred from said plate onto a blanket positioned on a blanket cylinder that rotates on an axis generally parallel to the axis of rotation of said shaft, said blanket having an outer diameter that approximately coincides with the innermost location of the plate cylinder.

3. The apparatus of claim 1, wherein the ink is eventually transferred to a beverage container.

4. The apparatus of claim 1, wherein said inker gear is positioned between said servomechanical motor and said plate cylinder.

5. The apparatus of claim 1, wherein said servomechanical motor is interconnected to said shaft with a coupling.

6. The apparatus of claim 1, wherein said servomechanical motor is controlled by a computer system.

7. The apparatus of claim 6, wherein said computer system utilizes software adapted to change the speed of at least one servomechanical motor based on the registration timing of applying ink to a container body.

8. The apparatus of claim 1, further including a plurality of ink stations and a plurality of servomechanical motors in mechanical communication wherein said plurality of servomechanical motors control the selective rotation of said plurality of gears to dictate the location of ink onto a blanket for application of ink to a container.

9. The apparatus of claim 7, wherein eight ink stations and eight servomechanical motors are employed.

10. An inking apparatus driven and controlled by servomechanical motors which are adapted to apply indicia to a surface, comprising:
a central axis;
a plurality of ink stations interconnected spaced in a arcuate fashion with respect to said central axis, said ink stations each having a reservoir for containing ink and a plurality of mechanically interconnected gears for controlling the application of ink to an inking cylinder;
a plurality of servomechanical motors in mechanical communication with said plurality of gears of said plurality of ink stations and to said inking cylinder; and
wherein said plurality of servomechanical motors control the movement of said plurality of gears of said plurality of ink stations and said inking cylinder to control the placement of ink from said ink stations onto the inking drum.

11. The apparatus of claim 9, wherein said plurality of servomechanical motors are controlled by a computer system.

12. The apparatus of claim 9, further comprising a mandrel interconnected to a spindle disc adapted to secure a plurality of containers in a circular orientation at a diameter such that the containers are oriented perpendicular to said spindle disc; and
a blanket with an outer diameter, said blanket is oriented such that said generally circular outer diameter contacts said containers on said mandrel to impart indicia thereon.

13. A method of controlling the addition of an inked design onto a container, comprising:
providing a shaft that rotates a blanket cylinder;
monitoring the rotational position of said blanket cylinder;
providing a servomechanical motor that drives and controls the rotational position of an inking cylinder that interacts with said blanket cylinder; and
monitoring the rotational position of said inking cylinder.

14. The method of claim 12, further comprising comparing the rotational position of said blanket cylinder with the rotational position of said inking cylinder to assess the ink deposition position of the inking cylinder onto the blanket cylinder.

15. The method of claim 13, wherein said monitoring and said comparison is performed by a computer.

16. The method of claim 12, wherein said position or said blanket cylinder and said inking cylinder is monitored by an encoder.
